(19) United States
(12) Patent Application Publication
(10) Pub. No.: US 2019/0099760 A1
(43) Pub. Date: Apr. 4, 2019

(54) A Crusher

(71) Applicant: Trio Engineered Products, Inc., Irwindale, CA (US)

(72) Inventors: Kurt O'Bryan, Waukesha, WI (US); Jerrod Dulmes, New Berlin, WI (US)

(21) Appl. No.: 16/095,043

(22) PCT Filed: Apr. 20, 2017
(86) PCT No.: PCT/AU17/50355

§ 371 Date: Oct. 19, 2018

Related U.S. Application Data
(60) Provisional application No. 62/328,866, filed on Apr. 28, 2016.

(30) Foreign Application Priority Data
Apr. 21, 2016 (AU) 2016901488

(51) Int. Cl. B02C 2/04

(52) U.S. Cl. CPC B02C 2/04

(57) ABSTRACT

A cone crusher is described including: a stationary main shaft; and a crushing head; wherein the ratio of the diameter of the main shaft to the diameter of the head is greater than 0.3.

### TECHNICAL FIELD

This disclosure relates in general to crushing machines and, in particular to an improved cone crusher.

### BACKGROUND OF THE DISCLOSURE

A crusher is a machine designed to reduce large rocks into smaller rocks, gravel, or rock dust. Crushers are used to reduce the size of a solid mix of raw materials (such as a rock ore), so that particulates of different composition can be separated by beneficiation processes.

A cone crusher is a type of crusher which breaks rock by squeezing the rock ore between an eccentrically gyrating spindle, which is covered by a wear resistant mantle, and the enclosing concave hopper, which is usually covered by a manganese steel bowl liner. As rock ore enters the top of the cone crusher, it becomes wedged and squeezed between the mantle and the bowl liner. Large pieces of ore are broken once, and then fall to a lower position (because they are now smaller) where they are broken again. This process continues until the pieces are small enough to fall through a narrow opening at the bottom of the crusher, for further processing.

Cone crushing machines are susceptible to breakdown due to bearing or bushing failures. In the event of a breakdown, the cone crushing machine must be stopped and repaired which can lead to lost production time as well as the expense of making repairs. Furthermore, in a mineral processing facility, the breakdown of a cone crusher can have a disruptive effect on the operations upstream and downstream of the cone crusher.

There remains a need to provide improved cone crushers.

### SUMMARY OF THE DISCLOSURE

In a first aspect, there is provided a cone crusher including: a stationary main shaft; and a crushing head; wherein the ratio of the diameter of the main shaft to the diameter of the head is greater than 0.3.

In some embodiments, the cone crusher further includes an eccentric arranged to rotate about the main shaft, wherein at least one oil flow pathway is provided in the eccentric to allow oil to flow away from the head.

In a second aspect, there is provided a cone crusher including: a stationary main shaft; a crushing head; an eccentric which is arranged to rotate about the main shaft to cause oscillating movement of the crushing head; and a cylindrical eccentric bushing which is disposed between the outside surface of the main shaft and the inside surface of the eccentric; wherein the ratio of the diameter of the eccentric bushing to the length of the eccentric bushing lies in a range between about 0.8 and about 1.2.

In some embodiments, the ratio lies in the range between about 0.9 and about 1.2. In some embodiments, the ratio lies in the range between about 0.93 and about 1.2. In some embodiments, the ratio lies in the range between about 0.9 and about 1.0. In one particular embodiment, the ratio is about 0.93.

In a third aspect, there is provided a cone crusher including: a stationary main shaft; a crushing head; an eccentric which is arranged to rotate about the main shaft to cause oscillating movement of the crushing head; and a generally circular liner which is provided between the top of the main shaft and the crushing head to support the oscillating head on the shaft, wherein the ratio of the diameter of the main shaft to the diameter of the liner is greater than about 1.0.

In some embodiments, the ratio of the diameter of the main shaft to the diameter of the liner lies in the range between about 1.0 and about 1.2. In one particular embodiment, the ratio of the diameter of the main shaft to the diameter of the liner is about 1.05.

Other aspects, features, and advantages will become apparent from the following detailed description when taken in conjunction with the accompanying drawings, which are a part of this disclosure and which illustrate, by way of example, principles of the inventions disclosed.

### BRIEF DESCRIPTION OF THE DRAWINGS

The accompanying drawings facilitate an understanding of the various embodiments.

FIG. 1 is a cross-sectional view of a prior art cone crusher; and

FIG. 2 is a cross sectional view of a sub-assembly for a cone crusher in accordance with this disclosure; and

FIG. 3 is a cut away view of a cone crusher including the sub-assembly of FIG. 2.

### DETAILED DESCRIPTION OF EMBODIMENTS

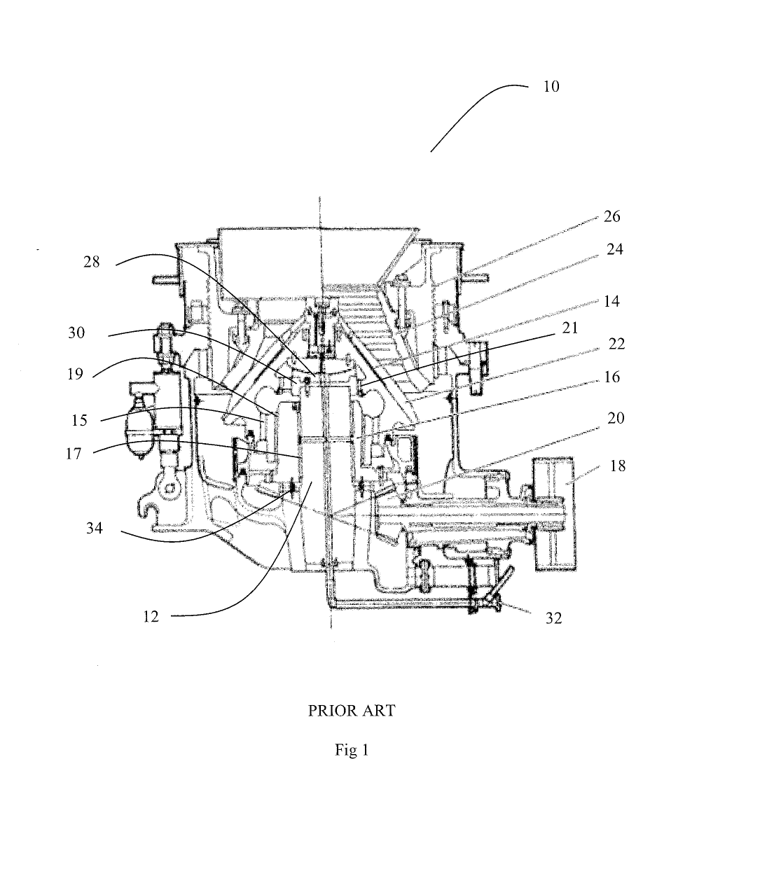

Referring to FIG. 1, a typical prior art cone crusher 10 is shown in cross section. The cone crusher 10 includes a fixed main shaft 12 upon which is mounted a head 14. An eccentric 16 is mounted between the shaft 12 and the head 14. A bush known as an eccentric bush 17 is disposed between the inner surface of the eccentric 16 and the main shaft 12. A bush known as the lower head bush 19 is disposed between the outer surface of the eccentric 16 and the head 14.

A pulley 18 is driven by an engine or motor (not shown) which rotates a drive pinion 20 which engages with a toothed gear mounted at the underside of the eccentric 16. The outer surface of the eccentric 16 is in the shape of a cylinder whose central axis is angularly inclined with respect to the central axis of the main shaft 12. The eccentric 16 operates as a type of cam. Rotation of the eccentric 16 causes the head 14 to move in a circular oscillatory fashion. This oscillating movement causes rock which is fed into the upper opening of the cone crusher 10 to become crushed in between a wear resistant head liner 22 and a wear resistant bowl liner 24. As the rock breaks up into smaller pieces, it makes its way downwardly under the influence of gravity to be crushed again during a subsequent oscillation of the head at a narrower region between the head liner 22 and the bowl liner 24. When the pieces of rock are sufficiently small, they pass through the gap between the head liner 22 and the lower edge of bowl liner 24 to emanate from the lower region of the crusher. The rock pieces are transported away from the lower region of the crusher to subsequent mineral processing operations. The size of rock pieces which are permitted to leave the crusher is determined by the clearance between the bowl liner 24 and the head liner 22 which can be adjusted by way of rotating a threaded assembly 26 holding the wear resistant bowl liner within a threaded ring assembly fixed to the outer frame of the crusher 10.

A liner 28 is mounted to the top of the main shaft 12 by way of an intermediate socket 30 which is an interference fit with the top of the main shaft 12. The liner 28 supports the head 14 on the main shaft 12 and has a concave upper surface to accommodate the oscillatory movement of the head 14. Upper head bush 21 bears against the outer surface of the socket 30. Oil under pressure is delivered into a pipe 32 to lubricate the moving parts of the cone crusher 10. Oil galleries in the main shaft 12 direct oil to lubricate the eccentric bush 17 and the lower head bush 19. Oil emanating from the lower end of the eccentric bush 17 lubricates a horizontally disposed circular thrust bearing 34. Oil in the head 14 lubricates the upper head bush 21. Passageways 15 in the head 14 allow oil to drain out of the head 14 to return to a sump where the oil is recirculated.

The liner 28, head liner 22, bowl liner 24, eccentric bush 17, lower head bush 19, upper head bush 21 and thrust bearings 34 are all wear components which are required to be replaced from time to time.

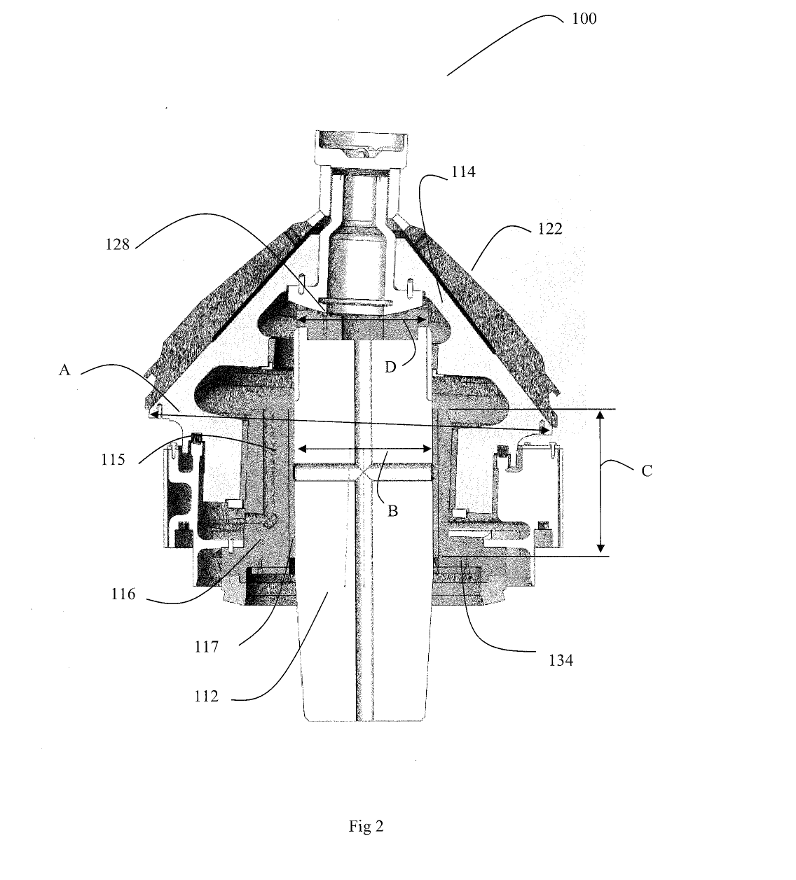

Referring to FIG. 2, a sub-assembly 100 for an improved cone crusher is shown. The sub-assembly forms part of a cone crushing machine with the same general operating principles as the machine shown in FIG. 1 but with various improvements. Like parts to FIG. 1 are indicated by like reference numerals in the series 100-199.

The main shaft 112 of the sub-assembly 100 is of increased diameter with respect to the diameter of the head 114 compared to the prior art. The ratio of the diameter of the main shaft 112 indicated by arrow B to the diameter of the head 114 at its widest point indicated by arrow A. In contrast, the same ratio measured in the prior art cone crusher of FIG. 1 is 0.25. The increased relative diameter of the main shaft 112 leads to various operational improvements. In particular, it permits the use of bushings of a greater diameter which are therefore subjected to a lower force per unit area loading. This increases the service life of the bushings and thus improves the reliability of the crusher.

In the sub-assembly 100 of FIG. 2, oil passageways 115 are provided in the eccentric 116 to allow oil to drain out of the head 114. There are no oil passageways in the head 114. This improves the structural integrity of the head because the possibility of head failure by cracking in the region of the oil passageways is avoided.

The eccentric bushing 117 of the sub-assembly 100 of FIG. 2 has a comparatively greater diameter to length ratio than eccentric bushings of known prior art cone crushers. The ratio of the diameter of the eccentric bushing 117 (also indicated by arrow B—it is equal to the main shaft diameter) to the length of the eccentric bushing (indicated by arrow C) is 0.93 whereas in prior art cone crushers this ratio is less than 0.8. Because of its greater diameter to length ratio the eccentric bushing 117 of the present disclosure has both a low unit area force loading (which increases the service life or load carrying capacity of the bushings and thus improves the reliability of the crusher) whilst also providing adequate space above the eccentric bushing 117 for the remaining head assembly components of the crusher.

In FIG. 2, the liner 128 is mounted directly to the top of the main shaft 112 with no use made of an intervening socket. The ratio of the diameter of the main shaft 112 (indicated by arrow B) to the diameter of the liner (indicated by arrow D) is 1.05. That is to say, the diameter of the liner 128 is smaller than the diameter of the main shaft 112. This results in the liner 128 being fully supported on the main shaft 112 which reduces the likelihood of cracking and failure of the liner 128.

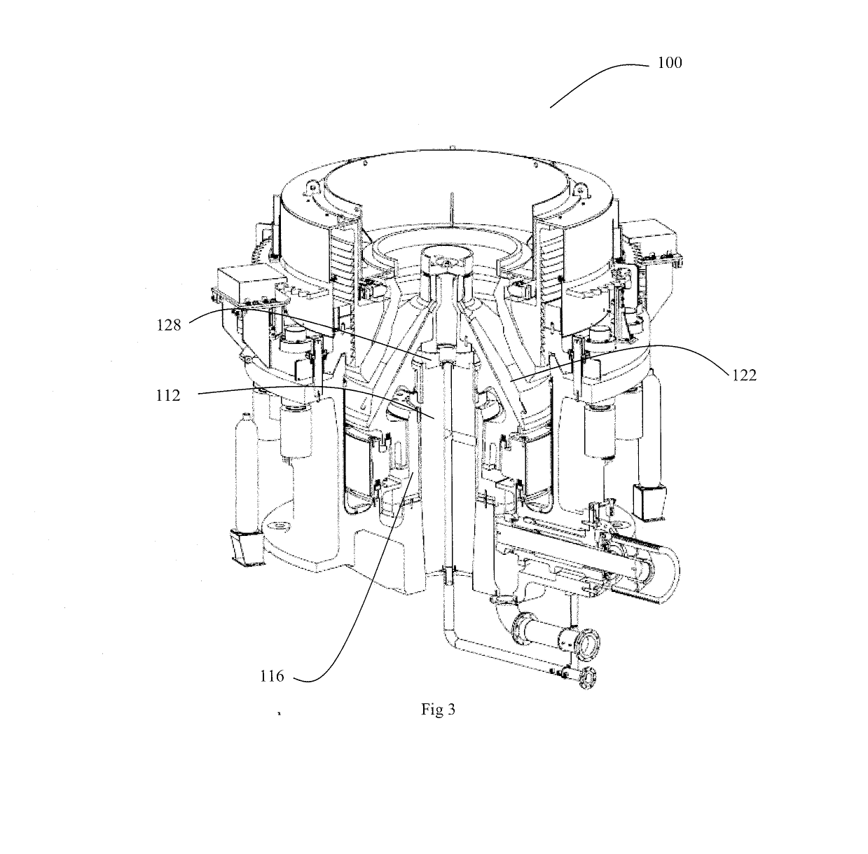

Referring to FIG. 3, the sub-assembly of FIG. 2 is shown installed in a cone crusher in a cut-away view.

It can be seen that embodiments of the cone crusher according to this disclosure offer at least one or more of the following advantages:
an increased diameter of main shaft to fully support a full size liner without the need for an interference fit socket;
an increased size diameter of eccentric bushing to provide a lower force per unit area loading;
an increased diameter and surface area of eccentric and mainframe thrust bearing plates;
the larger diameter main shaft creates a lower load and frictional heat on the main shaft thus reducing the potential for heat-induced cracking on the surface of the main shaft;
an increased eccentric area, greater structural integrity and provide greater space for oil drain holes through which all or most oil must drain that reports or travels into the upper cavity of the head assembly.
the elimination of oil drain holes allowing for a stronger overall head design;
an improved ease of maintenance improved by eliminating an interference fit socket;
lower oil flow requirements due to lower unit loading on bushings;
reduced oil loss due to lower oil flow and direction of drain oil down eccentric, rather than through head drain holes; and
smaller pinion which reduces the size of the mainframe arm.

In the foregoing description of certain embodiments, specific terminology has been resorted to for the sake of clarity. However, the disclosure is not intended to be limited to the specific terms so selected, and it is to be understood that each specific term includes other technical equivalents which operate in a similar manner to accomplish a similar technical purpose. Terms such as “left” and right”, “front” and “rear”, “above” and “below” and the like are used as words of convenience to provide reference points and are not to be construed as limiting terms.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

In addition, the foregoing describes only some embodiments of the invention(s), and alterations, modifications, additions and/or changes can be made thereto without departing from the scope and spirit of the disclosed embodiments, the embodiments being illustrative and not restrictive.

Furthermore, invention(s) have described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention(s). Also, the various embodiments described above may be implemented in conjunction with other embodiments, e.g., aspects of one embodiment may be combined with aspects of another embodiment to realize yet other embodiments. Further, each independent feature or component of any given assembly may constitute an additional embodiment.

1. A cone crusher including:
a stationary main shaft;
a crushing head; and
a cylindrical eccentric bushing which is disposed about the main shaft,
wherein the ratio of the diameter of the main shaft to the diameter of the head is greater than 0.3.

2. The cone crusher according to claim 1, further including:
an eccentric arranged to rotate about the main shaft;
wherein at least one oil flow pathway is provided in the eccentric to allow oil to flow away from the head.

3. A cone crusher including:
a stationary main shaft;
a crushing head;
an eccentric which is arranged to rotate about the main shaft to cause oscillating movement of the crushing head; and
a cylindrical eccentric bushing which is disposed between the outside surface of the main shaft and the inside surface of the eccentric;
wherein the ratio of the inside diameter of the eccentric bushing to the length of the eccentric bushing lies in a range between about 0.8 and about 1.2.

4. The cone crusher according to claim 3, wherein the ratio lies in the range between about 0.9 and about 1.2.

5. The cone crusher according to claim 3, wherein the ratio lies in the range between about 0.93 and about 1.2.

6. The cone crusher according to claim 3, wherein the ratio lies in the range between about 0.9 and about 1.0.

7. The cone crusher according to claim 3, wherein the ratio is about 0.93.

8. A cone crusher including:
a stationary main shaft;
a crushing head;
an eccentric which is arranged to rotate about the main shaft to cause oscillating movement of the crushing head; and
a generally circular liner which is provided between the top of the main shaft and the crushing head to support the oscillating head on the shaft,
wherein the ratio of the diameter of the main shaft to the greatest diameter of the liner is greater than about 1.0.

9. The cone crusher according to claim 8, wherein the ratio of the diameter of the main shaft to the diameter of the liner lies in the range between about 1.0 and about 1.2.

10. The cone crusher according to claim 8, wherein the ratio of the diameter of the main shaft to the diameter of the liner is about 1.05.
